(19) United States
(12) Patent Application Publication
(10) Pub. No.: US 2010/0183341 A1
(43) Pub. Date: Jul. 22, 2010

(54) DEVELOPING DEVICE, DEVELOPING METHOD, AND IMAGE FORMING APPARATUS

(75) Inventor: Takashi Ikeda, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/690,364

(22) Filed: Jan. 20, 2010

Related U.S. Application Data
(60) Provisional application No. 61/146,036, filed on Jan. 21, 2009.

(51) Int. Cl. G03G 15/08

(52) U.S. Cl. 399/255

(57) ABSTRACT

A container for containing a developer in a first chamber and second chamber partitioned by partitions is provided, fresh toner is supplied to the first chamber of the container, toner recovered from an image carrying member is supplied to the second chamber adjacent to the first chamber, and a path is provided in the partitions to flow the developer between the first and second chambers. A filter having a plurality of oblique slits is attached to the path, and the flow of foreign matter contained in the developer in the second chamber to the first chamber through the path is restricted.

### CROSS-REFERENCE TO RELATED APPLICATION

This application is based upon and claims the priority of U.S. Provisional Application No. 61/146,036, filed on Jan. 21, 2009, the entire contents of which are incorporated herein by reference.

### TECHNICAL FIELD

The present invention relates to an image forming apparatus using an electrophotographic recording method, and more particularly, an image forming apparatus including a developing device which recovers toner used for development to be re-used, and is capable of reducing the generation of image deterioration caused by effects of foreign matter such as paper powder contained in the recovered toner.

### BACKGROUND

In general, an image forming apparatus using an electrophotographic recording method aims a laser beam at a photoconductive drum to form an electrostatic latent image. The photoconductive drum forms a toner image using a developing device, and the toner image is transferred onto a sheet to obtain an image.

The photoconductive drum is provided with the developing device, and a toner cartridge is disposed to supply toner to the developing device. A developer contained in the toner cartridge is conveyed to the developing device. The developing device includes a developing roller for transferring the toner to the photoconductive drum and a mixer for agitating the toner with a carrier, and the developing roller and the mixer are rotated by a motor.

In an existing image forming apparatus, transferred residual toner adhered to a photoconductive drum is recovered by a cleaner and the recovered toner is re-used. However, since the recovered toner contains paper powder, when the recovered toner is injected into the developing device, the paper powder is also injected into the developing device.

The paper powder supplied to the developing device causes image deterioration, for example, image blur. In addition, there is a problem in that the paper powder becomes entangled and clogged in the developing device, so that developer cannot be conveyed to the regular development position, resulting in a streaked image.

In JP-A-2003-345205, there is disclosed a toner recovering device for mixing a clogging prevention material with recovered toner in order to remove paper powder incorporated into the recovered toner. In addition, in JP-A-2008-46505, there is disclosed an image forming apparatus including a plurality of cutters for finely disintegrating foreign matter such as paper powder contained in recovered toner.

However, in JP-A-2003-345205, the clogging prevention material needs to be mixed with the recovered toner. In addition, in JP-A-2008-46505, the plurality of cutters for disintegrating foreign matter such as paper powder needs to be provided.

### SUMMARY

An object of the invention is to provide a developing device capable of reducing the effects of foreign matter such as paper powder contained in recovered toner.

According to an aspect of the present invention, the developing device includes: a container that includes a first chamber and second chamber partitioned by partitions and contains a developer; a plurality of mixers that are respectively provided in the first and second chambers of the container to agitate and convey the developer; a developing roller that supplies the developer contained in the first chamber of the container to an image carrying member; a cleaner that removes residual toner on the image carrying member; a toner supply unit that supplies fresh toner to the first chamber of the container and recovers the toner removed by the cleaner to supply to the second chamber adjacent to the first chamber; a path that is provided in the partition to flow the developer between the first and second chambers; and a filter that has a plurality of slits to restrict the flow of foreign matter contained in the developer in the second chamber to the first chamber through the path.

### DESCRIPTION OF THE DRAWINGS

FIG. 1 is a view illustrating a configuration of an image forming apparatus according to an embodiment.

FIG. 2 is a front view illustrating a configuration of a developing unit.

FIG. 3 is a perspective view illustrating the configuration of the developing unit.

FIG. 4 is a front view illustrating an example of a filter attached to the developing unit.

FIG. 5 is a front view illustrating an oblique slit filter.

FIG. 6 is a front view illustrating a horizontal slit filter.

FIG. 7 is a front view illustrating a vertical slit filter.

FIG. 8 is a characteristic diagram showing an abundance ratio of paper powder in the developing unit.

FIG. 9 is a front view illustrating a modified example of a filter provided in a partition.

### DETAILED DESCRIPTION

Throughout this description, the embodiments and examples shown should be considered as exemplars, rather than limitations on the apparatus of the present invention.

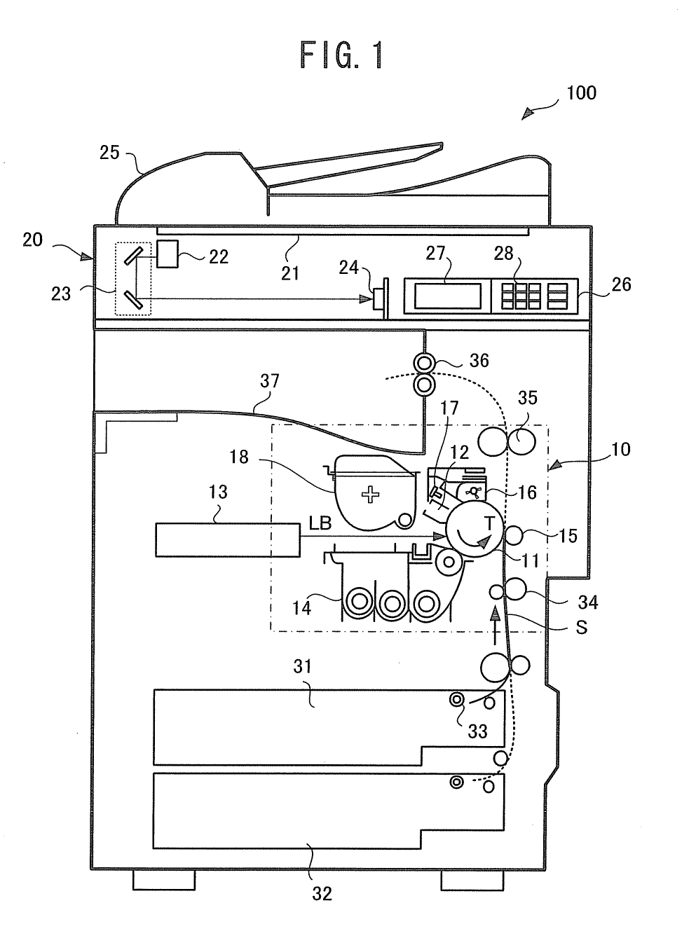

Hereinafter, an image forming apparatus according to an embodiment will be described in detail with reference to the accompanying drawings. Like elements are denoted by like reference numerals throughout the figures. FIG. 1 is a view schematically illustrating a configuration of an image forming apparatus 100 as viewed from a front (front side) according to an embodiment. In addition, in FIG. 1, a multi-function peripheral is exemplified as the image forming apparatus 100. For example, a copy machine, a printer, or the like may be applied.

The image forming apparatus 100 includes an image forming unit 10 at the center. The image forming unit 10 includes a photoconductive drum 11 which can rotate. The photoconductive drum 11 is an image carrying member and has a photoconductor on its outer peripheral surface. When the photoconductive drum 11 is irradiated with light in a state of being given a predetermined potential, the potential at the region irradiated with light changes, and the change in the potential is maintained for a predetermined time as an electrostatic latent image.

In the vicinity of the photoconductive drum 11, along a rotation direction T of the photoconductive drum 11, an electrostatic charger 12, an exposure unit 13, a developing unit 14, a transfer roller 15, a drum cleaner 16, and a discharge lamp 17 are provided.

The electrostatic charger 12 charges a surface of the photoconductive drum 11 to a predetermined potential. The exposure unit 13 has an aiming position on the downstream side of the rotation direction T of the photoconductive drum 11 from the electrostatic charger 12 and aims a laser beam LB at the photoconductive drum 11 to form an electrostatic latent image on the surface of the photoconductive drum 11. The laser beam LB changes the light emitting intensity with image density or the like.

The developing unit 14 contains a two-component developer composed of carrier and tone and supplies the developer to the surface of the photoconductive drum 11 to develop the electrostatic latent image of the photoconductive drum 11. The electrostatic latent image on the surface of the photoconductive drum 11 is made to be visible thereby forming a toner image. The transfer roller 15 gives a predetermined potential to a sheet S to transfer the toner image on the photoconductive drum 11 to the sheet S. The drum cleaner 16 removes the residual toner adhered to the surface of the photoconductive drum 11 to recover the toner. The discharge lamp 17 removes the remaining charge from the photoconductive drum 11.

Above the developing unit 14, a toner cartridge 18 is disposed for supplying fresh toner to the developing unit 14. When the toner in the developing unit 14 is consumed, the fresh toner is supplied to the developing unit 14 from the toner cartridge 18. The toner cartridge 18 may be replaced by a user.

At an upper portion of the image forming apparatus 100, a scanner 20 is provided. The scanner 20 reads a document placed on a document platen 21. The scanner 20 includes a light source 22 which aims light at the document placed on the document platen 21, a reflection mirror 23 which reflects the light reflected from the document, and a light receiving element 24 which receives the light reflected from the reflection mirror 23.

An automatic document feeder (ADF) 25 and an operation panel 26 are provided on the document platen 21. The operation panel 26 includes a touch panel-type display unit 27 and an operation unit 28.

At a lower portion of the image forming apparatus 100, plural-stage paper feed cassettes 31 and 32 are disposed. Sheets S (recording medium) loaded on the paper feed cassettes 31 and 32 are carried upward by a pickup roller 33, an aligning roller 34, and a fixing roller 35 and discharged to a paper discharge tray 37 by a paper discharge roller 36.

The pickup roller 33 picks up the sheets S in the paper feed cassettes 31 and 32 one by one to carry the sheets S to the aligning roller 34. The aligning roller 34 rotates at a predetermined timing to align a position of the sheet S with the toner image formed on the photoconductive drum 11 and carries the sheet S to a transfer position.

The fixing roller 35 heats and presses the sheet S to which the toner image is transferred by the transfer roller 15 to fix the toner image on the sheet S. The paper discharge roller 36 carries the sheet S discharged from the fixing roller 35 to the paper discharge tray 37.

During the image formation, a light is aimed at the document on the document platen 21 by the light source 22, and the light reflected from the document is input to the light receiving element 24 via the reflection mirror 23 to read the document image. On the basis of the information read by the light receiving element 24 or image information supplied from the outside such as a PC (Personal Computer), the exposure unit 13 outputs the laser beam LB to aim the laser beam LB at the surface, of the photoconductive drum 11. The surface of the photoconductive drum 11 is negatively charged by the electrostatic charger 12, and the photoconductive drum 11 is exposed to the laser beam LB output from the exposure unit 13, thereby an electrostatic latent image is formed on the surface of the photoconductive drum 11.

The electrostatic latent image formed on the photoconductive drum 11 attracts the toner in the developing unit 14 and becomes a visible image (toner image). When the sheet S picked up from the paper feed cassette 31 or 32 is carried, the visible image on the photoconductive drum 11 is transferred onto the sheet S by the transfer roller 15. The sheet S to which the image is transferred is carried to the fixing roller 35 and heated and pressed by the fixing roller 35, thereby the image is fixed on the sheet S. The sheet S on which the image is fixed is discharged to the paper discharge tray 37 via the paper discharge roller 36.

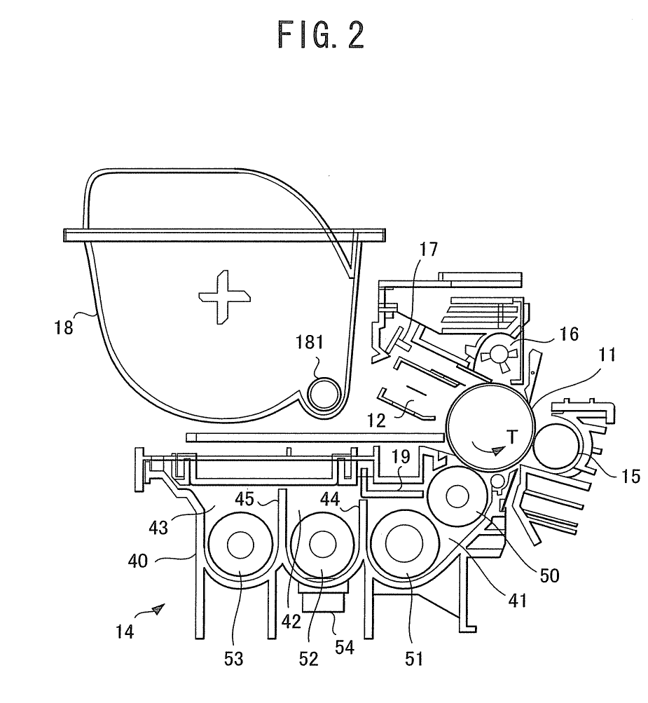

FIG. 2 is a view illustrating a configuration of a developing device in detail, and specifically is a front view of the developing unit 14 as viewed from a front (front side).

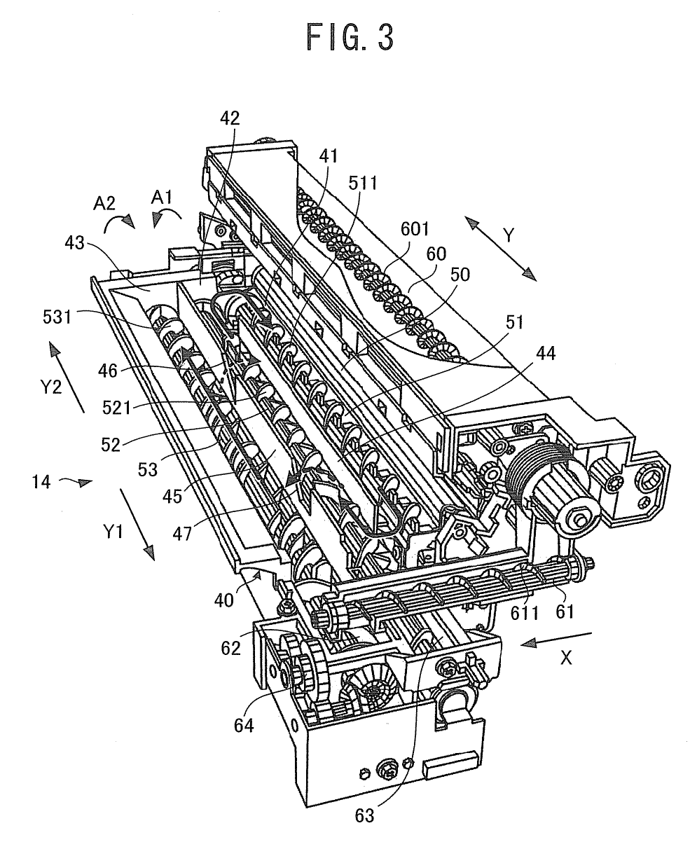

As illustrated in FIG. 2, the developing unit 14 is supplied with the fresh toner from the toner cartridge 18. The toner cartridge 18 contains the fresh toner and includes a supply roller 181 which is rotated by a motor to supply the fresh toner to the developing unit 14 by the supply roller 181. In addition, the drum cleaner 16 conveys the recovered recycled toner to the developing unit 14 (conveyance mechanism will be described later with reference to FIG. 3).

The developing unit 14 includes a container 40 for containing the two-component developer (hereinafter, referred to as developer) composed of the carrier and the toner, and the container 40 includes three chambers 41, 42, and 43. In order to partition the container 40 into the three chambers 41, 42, and 43, partitions 44 and 45 are provided.

The chamber 41 of the container 40 is provided with a developing roller 50 opposed to the photoconductive drum 11, and a first mixer 51. In the vicinity of the photoconductive drum 11, the electrostatic charger 12 is disposed on an upstream side of the developing roller 50, and on a downstream side thereof, the transfer roller 15, the drum cleaner 16, and the discharge lamp 17 are disposed in this order.

The chamber 42 of the container 40 is provided with a second mixer 52, and the chamber 43 of the container 40 is provided with a third mixer 53. In addition, the chamber 42 is provided with a magnetic sensor 54 for detecting a density of the toner contained in the container 40. The magnetic sensor 54 is preferable that disposed at a lower portion of the container 40.

In addition, a layer regulation blade 19 is provided for the developing roller 50 so that a developer layer on the surface of the developing roller 50 is regulated by the layer regulation blade 19 so as not to be thickened.

FIG. 3 is a perspective view illustrating the configuration of the developing device. In FIG. 3, the container 40 of the developing unit 14 extends in a Y direction in parallel with a shaft of the photoconductive drum 11 rearwards from the front side. The partitions 44 and 45 also extend in parallel with the shaft of the photoconductive drum 11. The partition 44 has such a length to connect the chambers 41 and 42 on both front and rear sides, and the partition 45 has such a length to connect the chambers 42 and 43 on the front side.

In addition, a cover is attached to the container 40. In order to clearly show the internal structure, in FIG. 3, the cover is omitted. The developing roller 50 for supplying the developer (toner) to the photoconductive drum 11 is rotatably mounted in the chamber 41 of the container 40 to be opposed to the surface of the photoconductive drum 11, and the chamber 41 is provided with the mixer 51 having a shaft parallel with the axial direction Y of the photoconductive drum 11. The chamber 42 is provided with the mixer 52 having a shaft parallel with the Y direction, and the chamber 43 is provided with the mixer 53 having a shaft parallel with the Y direction. The mixers 51, 52, and 53 are driven by a gear (rotated by a driving unit of a main body of the image forming apparatus) provided on the rear side of the container 40.

The mixer 51 has a helical blade 511 to agitate and convey the developer in the chamber 41 from the rear side to the front side, that is, in the Y1 direction. The mixer 52 has a helical blade 521 and rotates in, for example, an A1 direction to agitate and convey the developer in the chamber 42 from the front side to the rear side, that is, in an Y2 direction. Therefore, the mixers 51 and 52 agitate and convey the developer circularly between the chambers 41 and 42.

The mixer 53 has a helical blade 531 and rotates in, for example, an A2 direction by a motor to agitate and convey the developer in the chamber 43 from the front side to the rear side, that is, in the Y2 direction.

Above the developing unit 14, the drum cleaner 16 for recovering the residual toner of the photoconductive drum 11 is provided. The drum cleaner 16 includes a conveyance roller 60 for toner recovery. The conveyance roller 60 has a helical blade 601 provided along its shaft extending in the Y direction and is rotated by a motor to convey the recovered toner from the rear side to the front side.

On a front side of the conveyance roller 60, a supply mechanism 61 is provided for conveying the toner for recycling (called recycled toner) recovered by the drum cleaner 16 to the chamber 43 of the container 40. The supply mechanism 61 has, for example, a helical blade 611 provided along its shaft extending in the X direction perpendicular to the axial direction Y of the photoconductor drum 11, and is rotated by a gear mechanism 64 to convey the recycled toner toward the chamber 43. The gear mechanism 64 is provided adjacent to the chamber 40 and is driven via a plurality of gears from the mixer 53.

The recycled toner is supplied from the supply mechanism 61 to a recycled toner supply unit 62 provided on a front side of the chamber 43. The recycled toner supplied to the supply unit 62 is conveyed in the Y2 direction by the rotation of the mixer 53. The recycled toner supply unit 62 is positioned on the upstream side of the flow of the developer of the chamber 43.

In addition, a fresh toner supply unit 63 is provided on a front side of the chamber 42. The supply unit 63 is supplied with the fresh toner by the supply roller 181 (FIG. 2) of the toner cartridge 18. The supply unit 63 is positioned on an upstream side of a flow of the developer of the chamber 42.

The partition 45 is provided with paths 46 and 47. The paths 46 and 47 are formed by cutting portions from the partition 45. The developer in the chamber 43 can be sent to the chamber 42 through the path 46 by the rotation of the mixers 53 and 52, and the developer in the chamber 42 can be sent to the chamber 43 through the path 47.

Therefore, the mixer 53 agitates and conveys the developer received from the mixer 42 with the recycled toner received from the supply mechanism 61 and can send it to the second mixer 52. The mixer 52 agitates and conveys the fresh toner received from the supply unit 63 with the developer received from the mixers 53 and 51 and sends it to the first mixer 53.

The mixer 51 agitates the developer received from the mixer 52 and conveys to the developing roller 50 so as to send the developer exfoliated from the developing roller 50 after the development to the mixer 52.

The conveyance directions of the developer in the chambers 41, 42, and 43 are shown by thick arrows, and the conveyance directions of the developer between the chambers 42 and 43 are shown by thick dotted lines.

The recycled toner is recovered by the drum cleaner 16 from the photoconductive drum 11 after the developing and transferring operations, and the recycled toner is supplied to the developing unit 14 (chamber 43) through the supply mechanism 61.

However, when the residual toner on the photoconductive drum 11 is recovered, foreign matter such as paper powder of the sheets is recovered along with the residual transfer toner and fog toner. There may be a case where cellulose fibers or the like are contained in the recovered paper powder. When foreign matter such as paper powder is incorporated into the developing unit 14, the foreign matter adheres to the photoconductive drum 11 and causes image deterioration. In addition, in some cases, the cellulose fibers are entangled to form a mass, and if the mass of cellulose fibers is clogged between the developing roller 50 and the layer regulation blade 19, a white streaked image results.

In this embodiment, in order to prevent the foreign matter such as paper powder from adhering to the photoconductive drum 11, filters 48 are attached to the paths 46 and 47 which are agitation paths of the recycled toner to connect the chambers 43 and 42 to each other. The filter 48 restricts the conveyance of the foreign matter such as paper powder and is provided with a plurality of oblique slits 49.

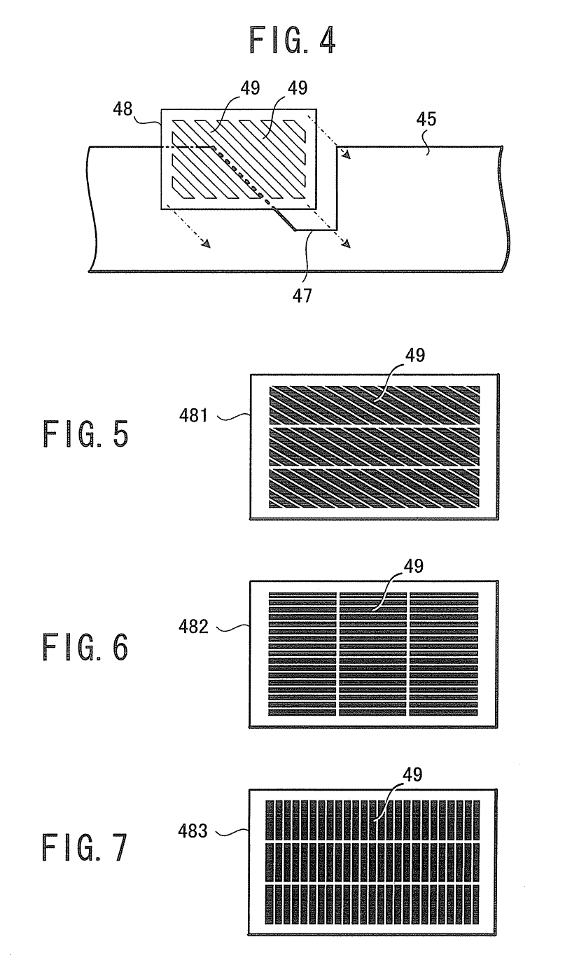

FIG. 4 is a front view illustrating an example of the filter 48. The filters 48 are attached to the paths 46 and 47 provided in the partition 45 (In FIG. 4, an example in which the filter 48 is attached to the path 47 is shown).

The filter 48 is provided with the plurality of parallel slits 49 which are oblique with respect to the shafts of the mixers 52 and 53, and the developer can be moved from the chamber 43 to the chamber 42, or from the chamber 42 to the chamber 43 through the slits 49. The movement of the foreign matter such as paper powder contained in the developer is restricted by the slits 49.

It is difficult to separate the foreign matter from the toner, however, after the foreign matter is mixed with the developer can be relatively easily separated. If the paths 46 and 47 are provided in the vicinity of the recycled toner supply unit 62 and the filters 48 are attached thereto, becomes difficult to separate the foreign matter from the toner, and the slits 49 are easily clogged. Therefore, preferable that the paths 46 and 47 be set at a position where the recycled toner and the developer are sufficiently agitated with each other, that is, a position distant from the supply unit 62 by a predetermined distance.

FIGS. 5 to 7 are front views illustrating examples of the filter 48 in which the shape of the slit 49 is changed. FIG. 5 shows a filter 481 having an oblique slit 49, FIG. 6 shows a filter 482 having a horizontal slit 49, and FIG. 7 shows a filter 483 having a vertical slit 49.

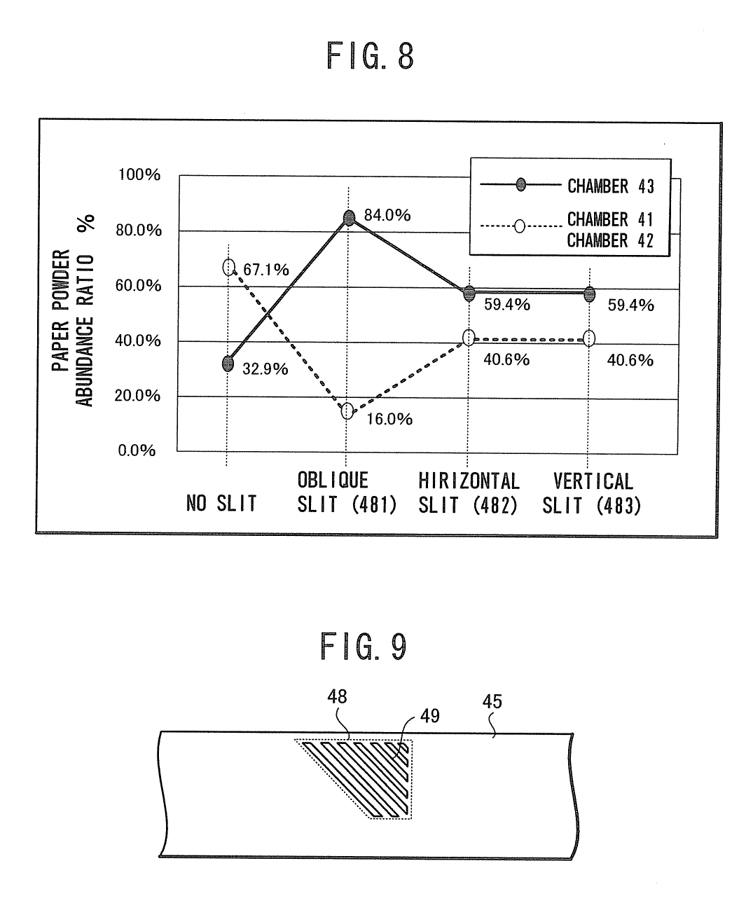

FIG. 8 is experimental data (characteristic diagram) showing abundance ratios of paper powder in the chambers 41, 42, and 43 when the filters 481, 482, and 483 are used. A thick full line in FIG. 8 represents a paper powder abundance ratio in the chamber 43, and a dotted line represents a paper powder abundance ratio in the chambers 41 and 42.

In FIG. 8, without the filter 48, the abundance ratio of paper powder in the chamber 43 is low, and the abundance ratios of paper powder in the chambers 41 and 42 are high. That is, a significant amount of paper powder flows from the chamber 43 to the chamber 42. When the filter 481 having the oblique slit is used, the abundance ratio of the paper powder in the chamber 43 is high, and the abundance ratios of the paper powder in the chambers 41 and 42 are low. That is, most of the paper powder remains in the chamber 43, and paper powder flowing to the chamber 42 or the chamber 41 hardly exists.

In addition, when the filter 482 or 483 having the horizontal slit or the vertical slit is used, as compared with the filter 481 having the oblique slit, the abundance ratio of the paper powder in the chamber 43 slightly decreases, and the abundance ratios of the paper powder in the chambers 41 and 42 increase. That is, it can be seen that the paper powder flows from the chamber 43 to the chamber 42.

Therefore, by using the filter 481 having the oblique slit, possible to reliably prevent the paper powder from flowing from the chamber 43 to the chambers 42 and 41. Since the developing roller 50 is provided in the chamber 41, as long as the incorporation of the paper powder into the chamber 41 is restricted, possible to prevent image deterioration and image blur during the development.

In addition, even when the filter 482 or 483 having the horizontal slit or the vertical slit is used, there is an effect in restricting the flow of the paper powder.

In addition, since paper powder is very light, there may be a case where the paper powder is rolled and raised during the agitation of the developer. When there is a gap between upper portions of the partitions 44 and 45 and the container 40, even though the paper powder is removed by the filter 481, the paper powder is incorporated into the chamber 42 from the chamber 43 via the gap at the upper portion and reaches the layer regulation blade 19 (FIG. 2).

Therefore, the partitions 44 and 45 may be set to be at such heights to come in contact with the cover of the container 40 so that the developer is conveyed only through the filters 48 provided in the paths 46 and 47. When the partitions 44 and 45 cannot be configured to come in contact with the cover of the container 40, upper spaces of the partitions 44 and 45 may be blocked by a cover sheet such as mylar.

FIG. 9 is a front view illustrating a modified example of the filter 48. FIG. 9 shows an example in which the oblique slit 49 is directly provided in the partition 45. That is, the filter 48 in FIG. 9 has functions of both the slit 49 and the paths 46 and 47.

Even the filter 48 illustrated in FIG. 9 makes it possible to keep the paper powder in the chamber 43, thereby restricting the flow of the paper powder in the chamber 42 or 41.

In addition, when the amount of the paper powder remaining in the chamber 43 is increased above a predetermined level, the chamber 43 is cleaned to remove the paper powder. Otherwise, the chamber 43 may be regularly cleaned by removing the paper powder.

According to the embodiment of the invention, possible to reduce the generation of image blur which is caused by paper powder or image deterioration caused by streaks or the like from the mass of the paper powder, thereby forming a stable image.

Modifications can be made without departing from the spirit and scope of the invention. Accordingly, the invention is not to be considered as being limited by the foregoing description, and is only limited by the scope of the appended claims.

Although exemplary embodiments are shown and described, it will be apparent to those having ordinary skill in the art that a number of changes, modifications, or alterations as described herein may be made, none of which depart from the spirit. All such changes, modifications, and alterations should therefore be seen as within the scope.

What is claimed is:

1. A developing, device comprising:
a container that includes a first chamber and second chamber partitioned by partitions and contains a developer;
a plurality of mixers that are respectively provided in the first and second chambers of the container to agitate and convey the developer;
a developing roller that supplies the developer contained in the first chamber of the container to an image carrying member;
a cleaner that removes residual toner on the image carrying member;
a toner supply unit that supplies fresh toner to the first chamber of the container and recovers the toner removed by the cleaner to supply to the second chamber adjacent to the first chamber;
a path that is provided in the partition to flow the developer between the first and second chambers; and
a filter that has a plurality of slits to restrict the flow of foreign matter contained in the developer in the second chamber to the first chamber through the path.

2. The device according to claim 1,
wherein the partition is provided with a plurality of the paths along a conveyance path of the developer, and
the filter is attached to the plurality of the paths.

3. The device according to claim 1, wherein the filter is configured by providing the plurality of slits in the partition so that the slit functions as the path.

4. The device according to claim 1, wherein the filter is configured by obliquely forming the slit along a conveyance path of the developer.

5. The device according to claim 1,
wherein a first mixer and a second mixer are disposed in the first chamber of the container in parallel with each other to circularly agitate and convey the developer,
a third mixer is disposed in the second chamber in parallel with the second mixer, and
the toner supply unit supplies the fresh toner to an upstream side of a conveyance path of the developer in the second mixer and supplies the recovered toner to an upstream side of a conveyance path of the developer in the third mixer.

6. The device according to claim 1, further comprising a scattering prevention member that prevents the foreign matter contained in the developer in the second chamber from scattering toward the first chamber over the partition.

7. The device according to claim 6,
wherein the scattering prevention member is configured by a cover of the container which covers the first and second chambers, and
the cover tightly comes in contact with an upper portion of the partition.

8. The device according to claim 6,
wherein the scattering prevention member is a cover sheet which covers upper portions of the first and second chambers, and
the cover sheet tightly comes in contact with an upper portion of the partition.

9. A developing method comprising:
containing a developer in a container which includes a first chamber and second chamber partitioned by partitions;
allowing the developer in the first and second chambers to be agitated and conveyed by a mixer;
supplying the developer contained in the first chamber of the container to an image carrying member by a developing roller;
removing residual toner on the image carrying member;
supplying fresh toner to the first chamber of the container and recovering the toner removed by the cleaner to supply to the second chamber adjacent to the first chamber; and
forming a path in the partition to flow the developer between the first and second chambers;
restricting the flow of foreign matter contained in the developer in the second chamber to the first chamber through the path by a filter having a plurality of slits.

10. The method according to claim 9,
wherein the partition is provided with a plurality of the paths along a conveyance path of the developer, and
the filter is attached to the plurality of the paths.

11. The method according to claim 9, wherein the plurality of slits are provided in the partition so that the slit has both functions of the path and the filter.

12. The method according to claim 9, wherein the filter is configured by obliquely forming the slit along a conveyance path of the developer.

13. The method according to claim 9,
wherein a first mixer and a second mixer are disposed in the first chamber of the container in parallel with each other to circularly agitate and convey the developer,
a third mixer is disposed in the second chamber in parallel with the second mixer, and
the fresh toner is supplied to an upstream side of a conveyance path of the developer in the second mixer and the recovered toner is supplied to an upstream side of a conveyance path of the developer in the third mixer.

14. The method according to claim 9, further comprising a scattering prevention member that prevents the foreign matter contained in the developer in the second chamber from scattering toward the first chamber over the partition.

15. An image forming apparatus comprising:
an image carrying member;
an exposure unit that exposes a surface of the image carrying member to form an electrostatic latent image;
a container that includes a first chamber and second chamber partitioned by partitions and contains a developer;
a plurality of mixers that are respectively provided in the first and second chambers of the container to agitate and convey the developer;
a developing roller that supplies the developer contained in the first chamber of the container to the image carrying member to develop the electrostatic latent image;
a transfer unit that transfers the developed visible image onto a recording medium;
a cleaner that removes residual toner on the image carrying member;
a toner supply unit that supplies fresh toner to the first chamber of the container and recovers the toner removed by the cleaner to supply to the second chamber adjacent to the first chamber;
a path that is provided in the partition to flow the developer between the first and second chambers; and
a filter that has a plurality of slits to restrict the flow of foreign matter contained in the developer in the second chamber to the first chamber through the path.

16. The apparatus according to claim 15,
wherein the partition is provided with a plurality of the paths along a conveyance path of the developer, and
the filter is attached to the plurality of the paths.

17. The apparatus according to claim 15, wherein the filter is configured by providing the plurality of slits in the partition so that the slit functions as the path.

18. The apparatus according to claim 15, wherein the filter is configured by obliquely forming the slit along the conveyance path of the developer.

19. The apparatus according to claim 15,
wherein a first mixer and a second mixer are disposed in the first chamber of the container in parallel with each other to circularly agitate and convey the developer,
a third mixer is disposed in the second chamber in parallel with the second mixer, and
the toner supply unit supplies the fresh toner to an upstream side of a conveyance path of the developer in the second mixer and supplies the recovered toner to an upstream side of a conveyance path of the developer in the third mixer.

20. The apparatus according to claim 15, further comprising a scattering prevention member that prevents the foreign matter contained in the developer in the second chamber from scattering toward the first chamber over the partition.
